(19) United States
(12) Patent Application Publication
(10) Pub. No.: US 2023/0374667 A1
(43) Pub. Date: Nov. 23, 2023

(54) METHOD FOR IMPROVING CORROSION AND FATIGUE CRACK RESISTANCE

(71) Applicant: ROLLS-ROYCE PLC, London (GB)

(72) Inventors: Glen PATTINSON, Derby (GB); Matthew C APPLETON, Derby (GB)

(73) Assignee: ROLLS-ROYCE PLC, London (GB)

(21) Appl. No.: 18/138,213

(22) Filed: Apr. 24, 2023

(30) Foreign Application Priority Data
May 18, 2022 (GB) 2207231.8

(51) Int. Cl. C23C 24/04

(52) U.S. Cl. CPC C23C 24/04

(57) ABSTRACT

A method for improving the corrosion and fatigue crack resistance of an article that has a surface. The method involves: providing a dry powder having one or more anti-corrosion materials; pressurising the dry powder to 1 to 5 MPa in an inert gas; pre-heating the surface of the article to a temperature of 50 to 900° C. and cold-spraying the surface of the article with the dry powder at a particle velocity of 300 to 1200 m/s so that a corrosion and crack-resistant coating is formed on the surface of the article and the surface is modified to an average depth of 10 to 100 μm.

### CROSS-REFERENCE TO RELATED APPLICATION

This specification is based upon and claims the benefit of priority from United Kingdom patent application number GB 2207231.8 filed on May 18 2022, the entire contents of which is incorporated herein by reference

### BACKGROUND

### Field of the Disclosure

The present disclosure concerns a method for improving the corrosion and fatigue crack resistance of articles, for example gas turbine engine components.

### Description of the Related Prior Art

Gas turbine engine components, especially high pressure turbine blades, are required to withstand exceptionally high temperatures and pressure during the operation of a gas turbine engine. They are made of specialised materials such as nickel-based superalloys. Wear to such components can arise in the form of corrosion, cracking and in extreme cases structural failure. Premature degradation can be costly and time consuming as the engine typically needs to be at least partially disassembled in order to inspect, repair or replace worn high pressure turbine blades.

It is known to at least delay the onset and extent of wearing of high pressure turbine blades and other gas turbine engine components by applying protective coatings to them. Protective coatings include various palliative diffusion coatings which use technologies such as electrolytic plating and chemical vapour deposition as a means of infusing anti-corrosion and anti-oxidation elements into the surface of the components. Surface reservoirs of aluminium, chromium, platinum and other elements that are created by such technologies provide the means to reduce excessive oxidation and corrosion and thereby slow wear and avoid component failure.

European patent application EP 3868914 A1 discloses method of manufacturing articles such as turbine blades for gas turbine engines. The method involves providing the article including a substrate and a coating at least partially disposed on the substrate. The coating has outer surface and includes platinum and chromium. The method further includes applying cold work to the outer surface of the coating to produce a cold-worked layer that extends from the outer surface of the coating to a cold work depth. The cold-worked layer includes approximately 45 percent cold work. The cold work depth is between about 30 microns to about 150 microns from the outer surface of the coating.

Many known protective coatings, particularly diffusion coatings, rely on slowing the rate of surface attack. This is underpinned by understanding the mechanisms by which degradation occurs however certain elements of such mechanisms are either not well understood or remain to be established by generally accepted evidence. This means while many protective coatings are known to be effective, some gas turbine components coated with such materials, particularly high pressure turbine blades, are still not providing commercially desirable service lives. Such gas turbine components are typically replaced to maintain high safety standards but that is time consuming and costly.

It is therefore desirable to provide protective coatings for articles e.g. gas turbine engine components, which provide such articles with improved corrosion and fatigue crack resistance, or at least provide a useful alternative to known protective coatings.

### SUMMARY OF THE DISCLOSURE

In a first aspect the present disclosure provides a method for improving the corrosion and fatigue crack resistance of an article that has a surface, the method comprising the steps of: providing a dry powder comprising one or more anti-corrosion materials; pressurising the dry powder to 1 to 5 MPa in an inert gas; pre-heating the surface of the article to a temperature of 50° C. to 900° C. prior to cold-spraying the surface of the article with the dry powder and cold-spraying the surface of the article with the dry powder at a particle velocity of 300 to 1200 m/s so that a corrosion and crack-resistant coating is formed on the surface of the article and the surface is modified to an average depth of 10 to 100 μm.

This applies cold spray technology as an effective deposition technique for articles including a gas turbine engine components e.g. single crystal gas turbine engine components.

In a second aspect the present disclosure provides a cold spray system for applying a corrosion and crack-resistant coating to an article that has a surface, the cold spray system comprising: a heater for heating the surface of the article to a temperature of 50° C. to 900° C., a holder for holding the article to which a corrosion and crack-resistant coating is to be applied; a source of dry powder comprising one or more anti-corrosion materials; and a cold spray gun for propelling the dry powder pressurised to 1 to 5 MPa in an inert gas towards a surface of the article at a particle velocity of 300 to 1200 m/s so that a corrosion and crack-resistant coating is formed on the surface of the article and the surface is modified to an average depth of 10 to 100 μm.

In a third aspect the present disclosure provides a gas turbine engine component coated that has a surface that has been modified by the method of the first aspect to improve its corrosion and fatigue crack resistance.

The gas turbine engine component may be a single crystal component and may be a turbine blade.

The term “diffusion coating” aka “surface alloying” as used herein means a method whereby an article, e.g. typically a metal article, which is required in use to withstand high temperature conditions and a highly corrosive environment is coated with a non-corrosive material. The method is typically carried out at an elevated temperature within a controlled chamber. The non-corrosive material is typically chromium, aluminium or silicon. The metal article is typically a steel, a refractory metal, or cobalt or nickel-based superalloy.

The term “cold spraying” as used herein is a comparatively low temperature solid state deposition process whereby a solid powder is accelerated onto a substrate with such impact that particles of the solid powder undergo plastic deformation and adhere onto the surface of the substrate. High pressure cold spraying typically involves using nitrogen or helium at pressures above 1.5 MPa, a flow rate of more than 2 m³/min, and a heating power of 6 kW. Whereas low pressure cold spraying typically involves using a compressed gas at a pressure from 0.5 to 1 MP, a flow rate of 0.5 to 2 m³/min, and a heating power of 3 to 5 kW. Unlike thermal spraying techniques such plasma spraying, arc spraying, flame spraying and high velocity oxygen fuel, cold sprayed powders are not subject to additional heating during the spraying process.

The term “single crystal component” (aka “monocrystalline component”) as used herein is a component composed of a solid material that has a crystal lattice that is continuous and substantially devoid of grain boundaries. The absence of any defects associated with grain boundaries typically gives the component unique mechanical, optical, electrical or other material properties. Single crystal components include gas turbine single crystal components.

Other than in the operating examples, or where otherwise indicated, all numbers expressing quantities of ingredients used herein are to be understood as modified in all instances by the term “about”.

Throughout this specification and in the claims that follow, unless the context requires otherwise, the word “comprise” or variations such as “comprises” and “comprising”, will be understood to imply the inclusion of a stated integer or group of integers but not the exclusion of any other stated integer or group of integers.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTIONS OF THE DRAWINGS

Embodiments will now be described by way of example only, with reference to the Figures, in which:

FIG. 1 is a schematic representation of the first stage of the method of the present disclosure.

FIG. 2 is a schematic representation of the first and second stages of the method of the present disclosure.

FIG. 3 is an electron micrograph image of a coating showing a splat formed by the method of the present invention. The coating comprises MCrAlY powder on INCONEL® 718 nickel-based superalloy. See Example 1.

FIG. 4 is a schematic representation of a cold spray system for applying a corrosion and crack-resistant coating to an article.

The following table lists the reference numerals used in the drawings with the features to which they refer:

| Ref no. | Feature | FIG. |
|---|---|---|
| 5 | Dry powder | 1 2 4 |
| 10 | Surface (of an article) | 1 2 4 |
| 15 | Article | 1 2 4 |
| 20 | Semi-spherical portion | 1 |
| 25 | Material jetting | 1 |
| 30 | Cold spray gun | 2 4 |
| 35 | Peened zone | 2 |
| 40 | Corrosion-resistant coating | 2 |
| 50 | Cold spray system | 4 |
| 55 | Holder (for an article) | 4 |
| 60 | Robotic arm (for holder) | 4 |
| 65 | Heater | 4 |
| 70 | Robotic arm (for cold spray gun) | 4 |
| 75 | Source of dry powder | 4 |
| 80 | Cold spray meter | 4 |
| 85 | Control unit | 4 |
| 90 | Control panel | 4 |

### DETAILED DESCRIPTION OF THE DISCLOSURE

Aspects and embodiments of the present disclosure will now be discussed with reference to the accompanying drawings. Further aspects and embodiments will be apparent to those skilled in the art.

The present disclosure provides a method for improving the corrosion and fatigue crack resistance of an article, a cold spray system for applying a corrosion and crack-resistant coating to an article, and a gas turbine engine component that has a surface that has been modified by the method to improve its corrosion and fatigue crack resistance.

As discussed above, various protective coating compositions for articles including gas turbine engine components are known. Known protective coatings include diffusion coatings which are difficult to provide.

Recent research indicates that at least some degradation modes affecting gas turbine engine components, more particularly high pressure turbine blades, typically involve a combination of corrosion and fatigue and that damage caused by the presence of surface contaminants and the extreme conditions to which such components are exposed in use cannot be successfully mitigated solely by the provision of a corrosion-resistant layers, steps must also be taken to mitigate early onset cracking.

Diffusion coating articles is challenging as it generally involves placing articles such as gas turbine engine components within a furnace and exposing those articles to temperatures in excess of 1000° C. in order to drive certain protective materials, e.g. chromium, aluminium or silicon, into the surface of the articles. Such processes are typically costly and time consuming. Furthermore the practical challenges involved often need to be factored into the choice of coating materials, which may mean having to accept some compromises in the formulation of the coating composition. In some cases, alloys have a time and temperature limit which must not be exceeded else base alloy materials properties like ultimate tensile stress and stress rupture cannot be guaranteed.

The use of these high temperature exposures means that traditional means of imparting compressive stress into the substrate subsurface such as shot peening and deep cold rolling are limited to the final operation only. This also means that it is not possible to impart this potentially useful work into the sub-surface earlier in the manufacturing process, thus limiting design and deployment options significantly.

Shot peening or deep cold rolling can be incompatible with certain anti-corrosion coatings. In such cases, as a subsequent operation, article treatment is typically restricted to either corrosion protection or fatigue crack protection, but not both.

Diffusion coatings by their nature are intimately bonded with their parent substrate and through metallurgical examination of service run hardware it has been observed that cracks that originate in surface layers face no obstruction to propagating immediately into the article. However once this occurs it is only a matter of cycles, wall thickness, stress and temperature before such cracks will propagate ultimately resulting in failure.

Other technologies can deliver surface layers which provide anti-corrosion materials but there is a definitive demarcation between the surface layer and the substrate which mitigates the risk of early onset cracks cracking the parent material.

The present disclosure provides a method for improving the corrosion and fatigue crack resistance of an article, for example a gas turbine engine component.

In a first aspect there is provided a method for improving the corrosion and fatigue crack resistance of an article, the method comprising the steps of:
(1) providing a dry powder comprising one or more anti-corrosion materials;
(2) pressurising the dry powder to 1 to 5 MPa in an inert gas; and
(3) cold-spraying the surface of the article with the dry powder at a particle velocity of 300 to 1200 m/s so that a corrosion and crack-resistant coating is formed on the surface of the article and the surface is modified to an average depth of 10 to 100 μm. Wherein the surface of the article is pre-heated to a temperature of 50 to 900° C. prior to cold spraying of the surface with the dry powder.

In the first step of the method a dry powder is provided and the dry powder comprises one or more anti-corrosion materials. An anti-corrosion material contains a chemical element that decreases the corrosion rate of an article, typically composed of a metal or an alloy, that comes into contact with corrosive compounds be they solid, liquid or gaseous. In some embodiments, the one or more anti-corrosion materials is an element selected from aluminium, chromium, silicon, yttrium, nickel, hafnium and cobalt.

In some embodiments the or at least one of the one or more anti-corrosion materials is chromium.

In some embodiments the or at least one of the one or more anti-corrosion materials is aluminium. It forms a coherent, continuous, adherent oxide which limits transmission of deleterious elements such as sulfur and oxygen.

In some embodiments, the or at least one of the one or more anti-corrosion materials is an alloy that comprises two, three or more of aluminium, chromium, silicon, yttrium, nickel, hafnium and cobalt, for example MCrAlY.

The dry powder comprising one or more anti-corrosion elements can be prepared or otherwise provided in any suitable form for the method of the present disclosure. In some embodiments the dry powder has an average particle size of 5 to 100 μm, for example 10 to 60 μm, or for example from 10 to 50 μm. However the selection of powder particle size typically involves a compromise between optimised coating formation and splatting characteristics and the desire to use larger particles to impart maximum sub-surface residual compressive stress on the article.

In the second step of the method the dry powder comprising one or more anti-corrosion elements is pressurised to 1 to 5 MPa with an inert gas. The inert gas may be, for example, nitrogen, argon, neon or helium gas. In this step the anti-corrosion material is carried in the inert gas and accelerated towards the article. In other words the inert gas is the means by which the powder is applied to the article using high kinetic energy.

The dry powder may be pressurised using any art known equipment that is suitable for that purpose. Examples of such equipment include the PLASMA™ PCS-1000 heater-gun with integrated cold spray unit from Plasma Giken Co. Limited, or the IMPACT™ cold spray gun 5/8 EvoCS11 or the IMPACT™ cold spray gun 6/11 EvoCS11 from Impact Innovations GmbH. The dry powder is pressurised to 1 to 5 MPa, for example 2 to 4 MPa, or for example 2.5 to 3.5 MPa, with an inert gas, for example nitrogen, argon, neon or helium gas.

In the third step of the method the surface of the article is cold-sprayed with the dry powder at a particle velocity of 300 to 1200 m/s so that a corrosion and crack-resistant coating is formed on the surface of the article and the surface is modified to an average depth of 10 to 100 μm. The method modifies the surface and underlying portion of the article that is cold-sprayed in the method. The skilled person in the art can adjust the conditions of the method steps in order to minimise or to maximise the depth to which the article, more particularly the surface and the portion of the article underlying the surface, is modified.

The pre-heating the surface of the article to a temperature of between 50 to 900° C. can be conducted using any suitable equipment or method, for example the surface of the article can conveniently be pre-heated using a cold spray gun that is also suitable for carrying out the third step of the method of the present disclosure. Alternatively individual heating elements enclosed within ceramic sheath can be positioned accordingly. In some embodiments the entire article may be pre-heated as discussed above rather than simply the surface of the article, although the convenience and practicality of that will depend on the article being treated using the method of the present disclosure. The step of pre-heating the surface may be prior to the first step of the method. Alternatively pre-heating may be concurrent with the first step and the second step or immediately before the third step.

Cold-spraying is a method for spray-coating an article or at least a surface of an article with a material. In particular, cold-spraying involves spraying the surface with powdered material which is accelerated in a supersonic gas jet under such conditions that the powdered material does not melt during the spraying process, i.e. particles of the powdered material are solid immediately prior to impacting the surface. On impact with the surface, the particles of the powdered material deform plastically, particularly through adiabatic shearing, causing the powdered material to flow locally and bond with the substrate.

Cold-spraying may be high-pressure cold-spraying (HPCS), which makes use of working gas pressures above about 1.5 MPa (and commonly up to about 7.0 MPa) and working gas pre-heated temperatures up to about 1100° C., or low-pressure cold-spraying (LPCS), which makes use of working gas pressures from about 0.5 MPa to about 1.0 MPa and working gas pre-heated temperatures lower than about 550° C. HPCS is particularly suitable for cold-spraying metals requiring higher critical velocities, such as Ti-based alloys or Ni-based superalloys. LPCS is particularly suitable for cold-spraying metals requiring lower critical velocities, such as Al-based or Cu-based alloys.

The cold spraying is conducted using any art known equipment that is suitable for the purpose. Examples of such equipment include the PLASMA™ PCS-1000 heater-gun with integrated cold spray unit from Plasma Giken Co. Limited, or the IMPACT™ cold spray gun 5/8 EvoCS11 or the IMPACT™ cold spray gun 6/11 EvoCS11 from Impact Innovations GmbH.

In some embodiments, the surface of the article is cold-sprayed with the dry powder at a particle velocity of 400 to 1000 m/s, for example 500 to 1000 m/s, or 700 to 900 m/s

In some embodiments, the surface of the article is cold-sprayed with the dry powder at an angle that is substantially perpendicular with the surface of the article. This facilitates the formation of a substantially even or homogenous coating on the article.

The third step forms a corrosion and crack-resistant coating on the surface of the article, whereby the surface of the article is modified to an average depth of 10 to 100 μm. In some embodiments, the surface of the article modified to an average depth of for example from 10 to 75 μm, or for example from 10 to 50 μm.

The article can take many forms. In some embodiments, the article is a single crystal.

In some embodiments, the article is a gas turbine engine component, i.e. a component of a gas turbine engine.

In some embodiments, the gas turbine engine component is a turbine blade, for example a high pressure turbine blade (from a high pressure turbine), an intermediate pressure turbine blade (from an intermediate pressure turbine), or a low pressure turbine blade (from a low pressure turbine).

In some embodiments, the pre-heating step involves heating the surface of the article to a temperature from 50° C. to 600° C., of for example from 50° C. to 300° C.

High temperature is applied to preheat the propellant gas during the spraying process but the term “cold gas spray” is due to the significantly lowered temperature (about 100° C.) of the expanded gas stream that is exiting the nozzle. Consequently, the temperature of the feedstock powder particles remains below their melting point and, therefore, the resulting coating is formed in the solid state. Successful deposition depends on a minimum particle velocity or “critical velocity,” which is affected by the thermo-mechanical properties of powder and substrate materials. At the critical velocity, the leading theory for deposition mechanism is that a high strain rate in the material leads to its plastic deformation during impingement and the formation of a region with adiabatic shear instability. In this unstable region, temperature can even reach the melting point of the material thus leading to viscoelastic material flow, formation of a conformal interface, and metallurgical bonding. Effectively the gas itself is of a lower temperature but the velocity is higher and particles undergo significant deformation upon impact with the surface of the substrate.

The method of the present disclosure for improving the corrosion and fatigue crack resistance of an article is summarised in the accompanying drawings.

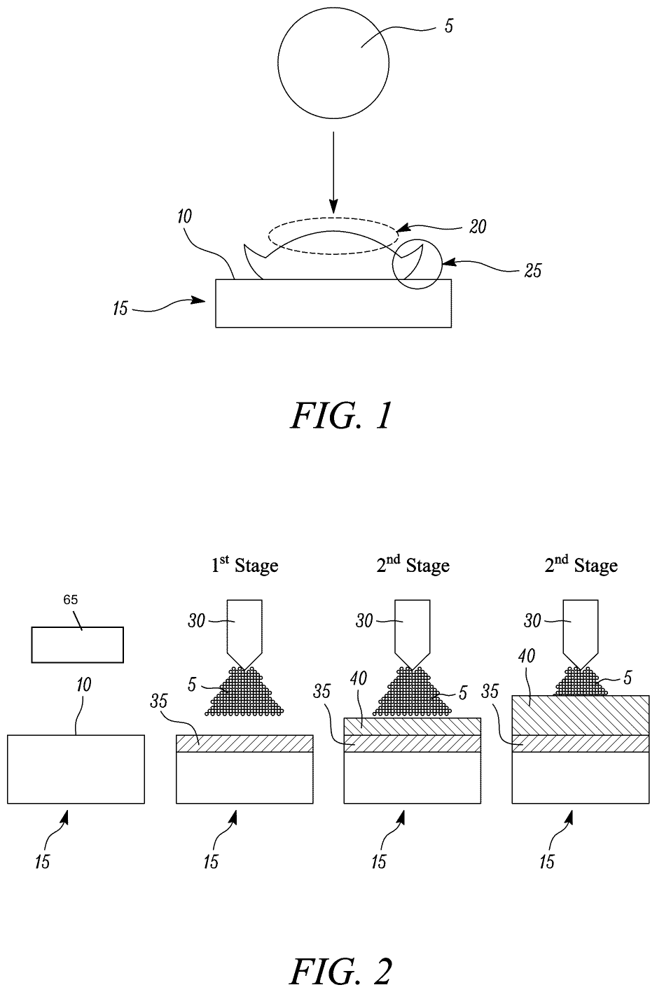

FIG. 1 is a schematic drawing where portion of dry powder 5 that comprises one or more anti-corrosion materials is accelerated onto a surface 10 of an article 15. The impact temporarily forms a semi-spherical portion 20 of the portion of dry powder 5 and some material jetting 25.

FIG. 2 is a schematic drawing that shows the method of the present disclosure being carried out to improving the corrosion and fatigue crack resistance of an article. The article 15 has a surface 10. A heater 65 pre-heats the surface of the article. A cold spray gun 30 is used to cold spray a dry powder 5 that comprises one or more anti-corrosion materials onto the surface 10 of the article 15. In a first stage of the cold spraying a peened zone 35 is created that retards fatigue crack initiation. In a second stage of the cold spraying a corrosion-resistant coating 40 is deposited on the peened zone 35 that protects the article from corrosion. However the speed of these actions are so fast to in effect provide simultaneous surface modification and coating deposition.

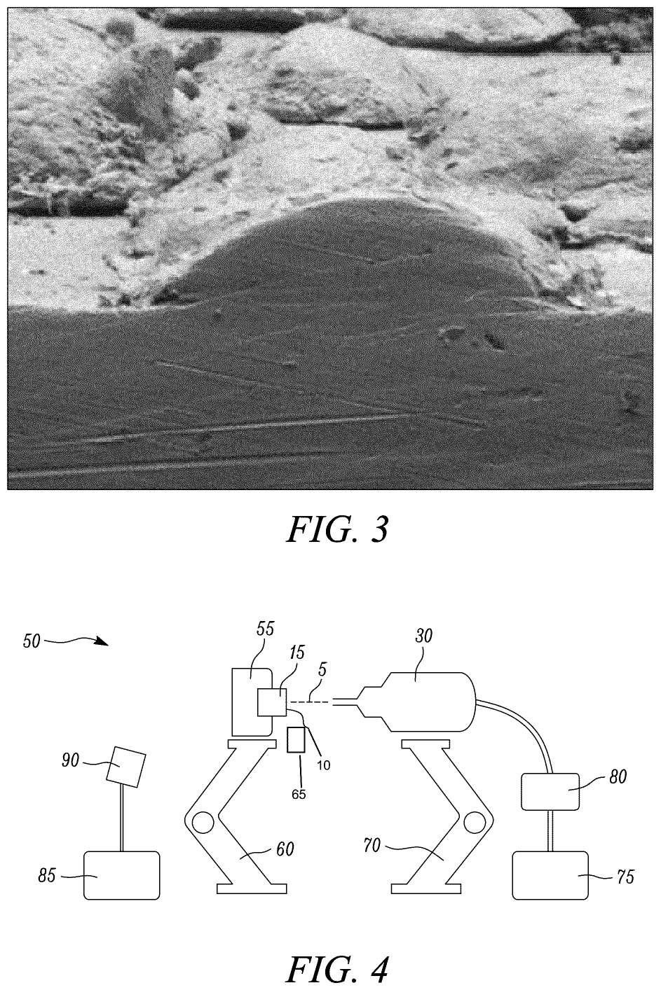

FIG. 3 depicts an electron micrograph image of MCrAlY dry powder cold sprayed onto a slab of INCONEL® 718 nickel-based superalloy.

In a second aspect there is provided a cold spray system for applying a corrosion and crack-resistant coating to an article, the cold spray system comprising:
a heater for pre-heating the surface of the article;
a holder for holding the article to which a corrosion and crack-resistant coating is to be applied;
a source of dry powder comprising one or more anti-corrosion elements; and
a cold spray gun for propelling the dry powder pressurised to 1 to 5 MPa in an inert gas towards a surface of the article at a particle velocity of 300 to 1200 m/s so that a corrosion and crack-resistant coating is formed on the surface of the article and the surface is modified to an average depth of 10 to 100 μm.

FIG. 4 is a schematic representation of a cold spray system 50 of the present disclosure.

The heater for pre-heating the surface of the article can take various forms, e.g. involving any suitable equipment or method. In some embodiments the cold spray gun may be utilised as the heater or in some embodiments individual heating elements enclosed within a ceramic sheath may be positioned accordingly.

The holder for holding the article can take various forms for the intended purpose. The form will generally depend on the article to which the cold spray system is to be used for applying a corrosion and crack-resistant coating to that article.

As mentioned above, the article can take various forms. In some embodiments, the article is a single crystal and/or in some embodiments, the article is a gas turbine engine component, e.g. a turbine blade.

The dry powder comprising one or more anti-corrosion materials can take various forms and can be prepared or otherwise provided in various ways. The source of such a powder can also take various forms. In some embodiments, the source of dry powder comprising one or more anti-corrosion materials is selected from aluminium, chromium and silicon. In some embodiments, the one or more anti-corrosion materials is an element selected from aluminium, chromium, silicon, yttrium, nickel, hafnium and cobalt, or an alloy comprising two, three or more of aluminium, chromium, silicon, yttrium, nickel, hafnium and cobalt, for example MCrAlY.

The spray gun can take various forms. Known spray guns that are typically suitable for the purpose include the PLASMA™ PCS-1000 heater-gun with integrated cold spray unit from Plasma Giken Co. Limited, and the IMPACT™ cold spray gun 5/8 EvoCS11 and the IMPACT™ cold spray gun 6/11 EvoCS11 from Impact Innovations GmbH.

In some embodiments, the surface of the article is cold-sprayed with the dry powder at a particle velocity of 400 to 1000 m/s, for example 500 to 1000 m/s, or 700 to 900 m/s.

In some embodiments, the surface of the article is modified to an average depth of 10 to 75 μm, or for example from 10 to 50 μm.

In some embodiments, the cold spray system also has a cold spray meter for metering the supply of dry powder to the cold spray gun. Such a cold spray meter can take various suitable forms.

In some embodiments, the cold spray system also has a control unit that controls the positioning of the holder, the heater temperature, the positioning of the cold spray gun, the metering of the supply of dry powder to the cold spray gun, and the propelling of the dry powder towards a surface of the article. The control unit can take various forms.

In some embodiments, the cold spray gun is mounted on a robotic arm.

In some embodiments, the holder for holding the article to which a corrosion and crack-resistant coating is to be applied is mounted on a robotic arm.

In a third aspect there is provided a gas turbine engine component that has a surface that has been modified by the aforementioned method to improve its corrosion and fatigue crack resistance.

In some embodiments, the gas turbine engine component is a single crystal and/or a turbine blade.

In FIG. 4 the cold spray system 50 includes a holder 55 for holding an article 15. The holder 55 is mounted on a robotic arm 60. A heater 65 is provided to pre-heat the surface of the article. A cold spray gun 30 is mounted on a robotic arm 70. The cold spray gun 30 receives dry powder 5 from a source 75 of dry powder. A cold spray meter 80 for metering the supply of dry powder 5 from the source of dry powder to the cold spray gun 30. The cold spray system 50 has a control unit 85 that controls the positioning of the holder 55, the temperature of the heater 65, the positioning of the cold spray gun 30, the metering of the supply of dry powder 5 to the cold spray gun 30, and the propelling of the dry powder 5 towards a surface 10 of the article 15. The control unit 85 conveniently includes a control panel 90.

The cold spray system 50 may be housed within a spray booth (not shown). The control unit 85 may be housed inside or but it (or at least the control panel 90 for the control unit 85 is typically more conveniently located outside of the spray booth. In some arrangements where a spray booth is used, the cold spray meter 80 may be located outside of the spray booth. The cold spray system 50 may include a cooling water pump (not shown), which may be located inside or outside of any spray booth.

In use, an article 15 that is to be treated by the method of the present disclosure to improve the corrosion and fatigue crack resistance of a surface 10 of that article 15 is removably but securely positioned into the holder 55 with the surface 10 of the article 15 exposed for treatment. If necessary the robotic arm 60 is activated to bring the holder 55 into the desired position for the article to be pre-heated and subsequently to be cold sprayed. The cold spray gun 30 is suitably positioned to cold spray the surface 10 of the article 15, which will typically involve activating the robotic arm 70 upon which the cold spray gun 30 is mounted via the using the control panel 90 of the control unit 85.

A dry powder 5 comprising one or more anti-corrosion materials is supplied to the cold spray gun 30 via the cold spray meter 80. The powder is pressurised to 1 to 5 MPa in an inert gas and then cold sprayed onto the surface 10 of the article 15 at a particle velocity of 300 to 1200 m/s so that a corrosion and crack-resistant coating is formed on the surface 10 of the article 15 and the surface 10 is modified to an average depth of 10 to 100 μm.

It will be understood that the invention is not limited to the embodiments above-described and various modifications and improvements can be made without departing from the concepts described herein.

### EXAMPLES

The follow example is provided to illustrate the method of the present disclosure.

### Example 1

Cold Spraying of an Article with MCrAlY Powder on INCONEL® 718 Nickel-Based Superalloy

A cold spray system for applying a corrosion and crack-resistant coating to an article to cold spray coat an article with MCrAlY powder on INCONEL® 718 nickel-based superalloy. The article is a slab of INCONEL® 718 nickel-based superalloy, which is a precipitation-hardenable nickel-chromium alloy containing significant amounts of iron, niobium, and molybdenum, designed to display exceptionally high yield, tensile and creep-rupture properties at temperatures up to about 704° C. (1300° F.). It is commercially available from Special Metals Corporation. Three such slabs are supported upright in a sample holder.

The system includes a PLASMA™ PCS-1000 heater-gun with integrated cold spray unit from Plasma Giken Co. Limited that is supported by a six-axis robotic arm within a spray booth. The cold spray gun is connected to a source of dry powder, more particularly a powder feeder charged with MCrAlY spray powder, Diamalloy™ 4700 powder from Oerlikon Metco.

The system has a heater for pre-heating the surface of the article.

The system also has a control unit, a control panel, a cold spray meter and a cooling water pump, all located outside of the spray booth.

The MCrAlY spray powder is pressurised in the powder feeder and cold sprayed onto the slabs of INCONEL® 718 nickel-based superalloy in accordance with the following cold spray parameters:

| Gas pressure | 4.5 MPa (45 bar) | |
|---|---|---|
| Gas temperature | 1000° | C. |
| Stand-off distance | 30 | mm |
| Powder feed rate | 10 g/min (working range | |
| | of 5 to 20 g/min | |
| Transverse speed | 500 | mm/s |
| Number of layers | 10 | |
| Particle velocity | Approximately 700 m/s | |
| Surface Temperature | 400° | C. |

The transverse speed is the rate of traverse of the part across in front of the gun, i.e. the part to be sprayed is moved in the x direction side to side very quickly in the stream of the cold spray gun.

The cold spraying process forms a coating on the surface of each slab. This coating is shown in the electron micrograph image that is depicted in FIG. 3. The coating comprises MCrAlY powder on INCONEL® 718 nickel-based superalloy.

The surface is modified to an average depth of 1 mm (1000 μm).

FIG. 3 shows the presence of individual “splats” as a result of the cold spray process and illustrates how layers of particle deposits combine in much the same way as traditionally thermally sprayed coatings.

1. A method for improving the corrosion and fatigue crack resistance of an article that has a surface, the method comprising the steps of:
providing a dry powder comprising one or more anti-corrosion materials;
pressurising the dry powder to 1 to 5 MPa in an inert gas; and
cold-spraying the surface of the article with the dry powder at a particle velocity of 300 to 1200 m/s so that a corrosion and crack-resistant coating is formed on the surface of the article and the surface is modified to an average depth of 10 to 100 μm;
wherein the surface of the article is pre-heated to a temperature of 50 to 900° C., prior to cold-spraying the surface of the article with the dry powder.

2. The method of claim 1, wherein the one or more anti-corrosion materials is selected from aluminium, chromium, silicon, yttrium, nickel, hafnium and cobalt.

3. The method of claim 1, wherein the dry powder comprises MCrAlY.

4. The method of claim 1, wherein the inert gas is selected from nitrogen, argon, neon and helium.

5. The method of claim 1, wherein the surface of the article is pre-heated to a temperature of 50 to 600° C., prior to cold-spraying the surface of the article with the dry powder.

6. The method of claim 1, wherein the dry powder has an average particle size of 5 to 100 μm.

7. The method of claim 1, wherein the surface of the article is modified to an average depth of 10 to 75 μm.

8. The method of claim 1, wherein the surface of the article is cold-sprayed with the dry powder at a particle velocity of 400 to 1000 m/s.

9. The method of claim 1, wherein the surface of the article is cold-sprayed with the dry powder at an angle that is perpendicular with the surface of the article.

10. The method of claim 1, wherein the article is a single crystal.

11. The method of claim 1, wherein the article is a gas turbine engine component.

12. The method of claim 11, where the gas turbine engine component is a turbine blade.

13. A cold spray system for applying a corrosion and crack-resistant coating to an article that has a surface, the cold spray system comprising:
a heater for heating the surface of the article;
a holder for holding the article to which a corrosion and crack-resistant coating is to be applied;
a source of dry powder comprising one or more anti-corrosion materials; and
a cold spray gun for propelling the dry powder pressurised to 1 to 5 MPa in an inert gas towards the surface of the article at a particle velocity of 300 to 1200 m/s so that a corrosion and crack-resistant coating is formed on the surface of the article and the surface is modified to an average depth of 10 to 100 μm.

14. The cold spray system of claim 13, further comprising a cold spray meter for metering the supply of dry powder to the cold spray gun.

15. The cold spray system of claim 13, further comprising a control unit that controls the positioning of the holder, the positioning of the cold spray gun, the metering of the supply of dry powder to the cold spray gun, and the propelling of the dry powder towards the surface of the article.

16. The cold spray system of claim 13, wherein the cold spray gun is mounted on a robotic arm.

17. The cold spray system of claim 13, wherein the holder for holding the article to which a corrosion and crack-resistant coating is to be applied is mounted on a robotic arm.

18. The cold spray system of claim 13, wherein the one or more anti-corrosion materials is selected from aluminium, chromium, silicon, yttrium, nickel, hafnium and cobalt, optionally MCrAlY.

19. The cold spray system of claim 13, wherein the surface of the article is cold-sprayed with the dry powder at a particle velocity of 400 to 1000 m/s; and the surface of the article is modified to an average depth of 10 to 75 μm.

20. A gas turbine engine component that has a surface that has been modified by the method of claim 1 to improve its corrosion and fatigue crack resistance.
